(19) United States
(12) Patent Application Publication
(10) Pub. No.: US 2024/0060581 A1
(43) Pub. Date: Feb. 22, 2024

(54) HIGH PRESSURE TUBE END FORM SUCH AS INCORPORATED INTO A HYDROGEN FUEL FILL TUBE

(71) Applicant: Martinrea International US Inc., Auburn Hills, MI (US)

(72) Inventor: Larry HARRIS, Otisville, MI (US)

(21) Appl. No.: 18/227,429

(22) Filed: Jul. 28, 2023

Related U.S. Application Data
(60) Provisional application No. 63/398,578, filed on Aug. 17, 2022.

(51) Int. Cl. F16L 19/028

(52) U.S. Cl. CPC F16L 19/0283

(57) ABSTRACT

A high pressure leak proof connection assembly and process for forming established between a male tube and a female port. The female end form has an interiorly threaded interface. The male end form is flare formed upon the male tube, with a sleeve being pressed on the tube during flare forming. A threaded hex nut is supported over the male tube and, upon insertion of the male end form into the female end form, is displaced forwardly into contact with the male flared end, with the exterior threads of the hex nut rotatably interengaging with the interior threads configured upon the female end form in order to establish the sealed connection.

### CROSS REFERENCE TO RELATED APPLICATIONS

The present application claims the priority of U.S. Ser. No. 63/398,578 filed Aug. 17, 2022.

### FIELD OF THE INVENTION

The present invention relates generally to a flared tube end joint fittings incorporated into high-pressure hydrogen fill tubes, such as provided with fuel cell applications. More specifically, the present invention discloses a flared end form utilized in a high-pressure hydrogen fuel tube for providing a secure and leak free connection with a tube mating female interface. The present invention also discloses a reconfigured flare end form for incorporation into a mid-line union joint, such as for addressing line routing complexities.

### BACKGROUND OF THE INVENTION

The prior art is documented with examples end connections for establishing a reliable seal between a tube and opposing ports, such as incorporated into a 70 MPA rated fuel cell application. The present invention also contemplates being modified, such as according to flare design and wall tube thickness, in use with lower pressure environments for fuel cell or hydrogen ICE engine applications, such as typically in a range of 35 MPA or 350 bar.

Being a small-molecule gas, hydrogen can leak through even the smallest of crevices and absorbed into the surrounding materials. In hydrogen-powered vehicles, a pressurized range up to approximately 700 bar of pressure is required to keep the necessary energy density in the hydrogen storage vessel. When hydrogen is refueled or recharged at refueling stations, the quick thermal and pressure changes can affect system integrity as the gas is released into the hydrogen storage vessel in order to raise the pressure back up to the max 700 bar pressure and decompresses. No leaks are permitted in either application.

For this reason the fittings in hydrogen applications, particularly those that connect the most critical parts of high-pressure hydrogen fuel systems, must be capable of delivering high levels of performance and reliability. Specialized options are required to contribute to those heightened performance demands in comparison to traditional cone and thread fittings ideal for hydrogen applications.

The flare fitting assembly of Schroeder U.S. Pat. No. 6,729,659 teaches a first coupling member and a second coupling member adapted to be cooperatively coupled together. The first coupling member has a first through bore with one end adapted to accept and retain a first tube. The second coupling member has a second through bore adapted to be disposed upon a second tube with an outwardly flared end. An arcuately shaped seating surface is disposed within the first through bore of the first coupling member. A conically flared seating surface is disposed within the second through bore of the second coupling member adapted to engage an outer surface of the flared end of the second tube such that a line seal is formed between the inner surface of the flared end of the second tube and the arcuate surface when the first and second coupling members are cooperatively coupled.

A further example of a related tube connection is depicted in U.S. Pat. No. 5,346,262, to Liebig, which is provided for thin-walled, small caliber metal tubes particularly for brake, fuel and hydraulic lines on motor vehicles and for use in refrigeration equipment, with at least one of the metal tubes being provided with a flange on the end to be connected and the metal tubes being encompassed by a sleeve in each case, one of which is deformable so as to form a fixed connection between the sleeves, the deformable sleeve being constructed as an outer sleeve which encircles the other sleeve constructed as an inner sleeve in the assembled condition at least over a portion of its length. The inner sleeve is provided with a circular thicker portion at the end nearest the flange so that a part of the outer sleeve is deformable behind this thicker portion.

A further example from the prior art is shown in CN 208793842 for a hard tube structure including a braking hard tube, hard tube bolt and hard tube nut. The hard tube bolt is connected with the hard tube nut thread, with both ends equipped with flaring about the braking hard tube.

### SUMMARY OF THE INVENTION

The present invention discloses a flared tube end joint fitting incorporated into high pressure hydrogen fill tubes for providing a secure and leak free connection with a tube mating female interface. In this fashion, the present invention provides a braze free method for establishing a tube mating interface to pass hydrogen gas leak rates, such as used globally for automotive applications.

The system components include each of the male tube form, a threaded hex nut supported over the male tube, and a flared tube mated to an internally threaded female mating port (the present design optionally including a female threaded nut and mating tube flare). The male tube exhibits a flared end and includes a sleeve pressed on during flare forming operation in order to be locked in place.

Upon insertion of the male tube end into the mating port or female flare nut, the hex or flare nut is displaced forwardly into contact with the male flared end, with the exterior threads of the hex nut rotatably interengaging with the interior threads configured upon the female mating port or female flare nut in order to establish the sealed connection. In this fashion, the mating interface between the male tube and female mating port or female flare tube nut requires a nominal sixty-degree port with the formed tube angle seated to the mating port. The sleeve pressed onto the male tube further allows for reduced friction in order to provide the force required to establish the seal.

The present invention also discloses an optional design which includes a female threaded nut and mating tube flare in which the female mating angle is formed onto an opposite tube to create a male flare tube flare to female flare tube joint. The redesigned joint provides flexibility in designing tube to tube connecting options for address complex routing situations, which may require a mid-line connection or service.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is length cutaway perspective of a hydrogen high pressure end-form mating to a hydrogen system component;

FIG. 2 provides a length cutaway illustration of the male tube end form which is flare formed to provide for multiple operations and including a sleeve pressed on during the flare forming operation;

FIG. 3 is a similar illustration to FIG. 1 with the system component removed and depicting the hydrogen end form which is formed on the tube;

FIG. 4 is a cutaway plan exploded view of the assembly shown in FIG. 1 and better depicting the flare nut loosely supported on the tube, the thickness of which varies based on the pressure specifications, along with the male tube end form and the hydrogen tube female mating interface;

FIG. 5 presents data relating to the hydrogen joint torque development associated with the connection established with the rotating hex nut in order to establish an optimal sealing force, forming a portion of the present invention;

FIG. 6 presents a further table illustrating torque verification over varying hydrogen test pressures;

FIG. 7 is a plan cutaway of a mid-line tube to tube joint connection according to a further embodiment of the present invention and showing an angled flare integrated into a female tube, and as opposed to the male tube in FIG. 1, in positioned and pre-final installed configuration;

FIG. 8 is a succeeding length plan view of an assembled mid-line tube to tube joint end form exhibiting a similar tube flare and nut depicted in the embodiment of FIG. 1 and in which the male nut is threaded into the union; and

FIG. 9 is a length cutaway of the installed mid-line union joint of FIG. 8 and in which the union is not allowed to rotate while the male nut is torqued per industry standards.

### DETAILED DESCRIPTION OF THE PREFERRED EMBODIMENTS

With reference to the attached illustrations, the present invention discloses a flared tube end joint fitting incorporated into high pressure hydrogen fill tubes for providing a secure and leak free connection with a tube mating female interface. As previously described, the present invention provides a braze free method for establishing a tube mating interface to pass hydrogen gas leak rates, such as used globally for automotive applications.

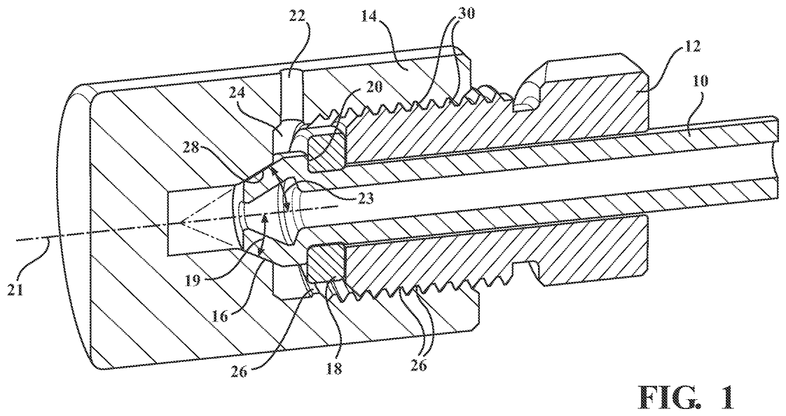

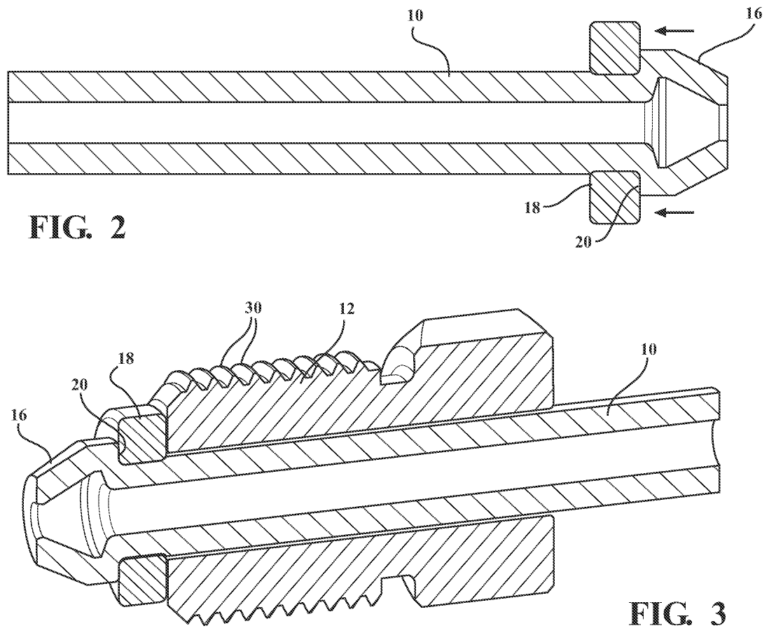

With reference to FIG. 1, a length cutaway perspective is provided of a hydrogen high pressure end-form mating to a hydrogen system component. The system components include each of the male tube form 10, a threaded hex nut 12 supported over the male tube, and a high pressure internally threaded female end form 14. As further depicted in FIG. 2, the male tube 10, such as which can include any suitable diameter or thickness (such being a variable of the pressure requirements). The tube 10 further exhibits a flared end 16 (such as which can be formed according to any press operation) which captures a sleeve 18 pressed on during flare forming operation in order to be locked in place.

The flared end 16 further defines an acute angle 19 relative to a centerline axis 21 extending along the tube 10. In a non-limiting and preferred embodiment, the angle 19 is at fifty-nine degrees relative to the centerline axis 21.

In one non-limiting application, the male tube 10 can include a 316L stainless steel (SS) seamless construction suitable for nominal 70 MPA or 10,000 psi H2 systems. The burst rating for such an application can exceed such as 350 MPA and the assembly passes H2 leak tightness requirements for all temperatures.

The sleeve 18 is likewise constructed of a 316L stainless steel material and is press-fit upon the tube 10 against an outer annular stepped surface 20 defining a base of the outer flare 16, this in order to prevent friction resulting from the tube and fastener. Non-limiting typical applications of the tube envision for use as a hydrogen fill tube such as for fuel cell vehicles, and by which the end form connection provides an H2 gas path an external fuel fill location to an H2 vessel.

In the assembled view of FIG. 1 a transverse extending pathway is shown at 22 in the female end form 14 extending from an internal interface 24 with the flare 16 of the male tube 10. The pathway 22 defines a mating interface or fill portion outlet of a fuel tank, such as a hydrogen storage vessel.

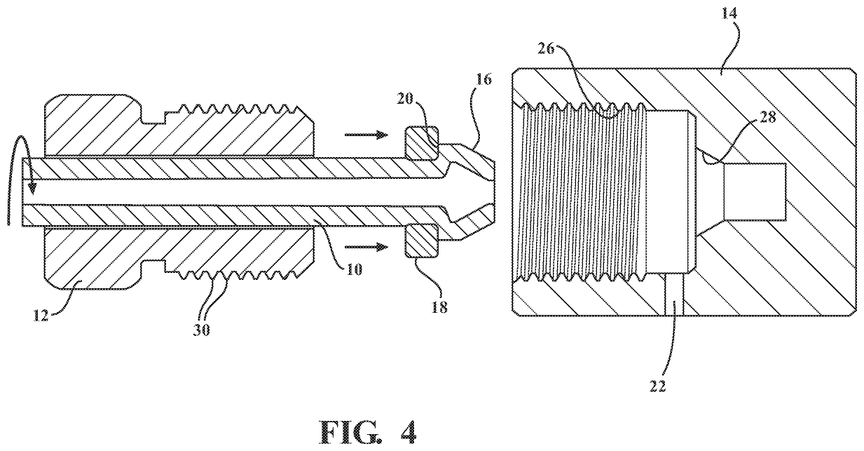

As best shown in FIG. 4, female interface 14 includes an interior threaded profile 26 communicating with its internal interface 24 (or pocket). This further includes an interior flared interface 28, which seats against the male flared end 16 in order to define the sealed connection.

As again shown in FIG. 1, the flared interface 28 defines a further angle 23 relative to the length extending axis 21 through the tube 10 centerline. The angle 23, in a non-limiting embodiment, can be established at a sixty degree angle relative to the length axis of the tube, and so that a one degree offset pinch point is established with the angle 19 (fifty nine degrees) exhibited by the annular flared end face 16 of the male tube end form, in order to establish the leak-proof connection.

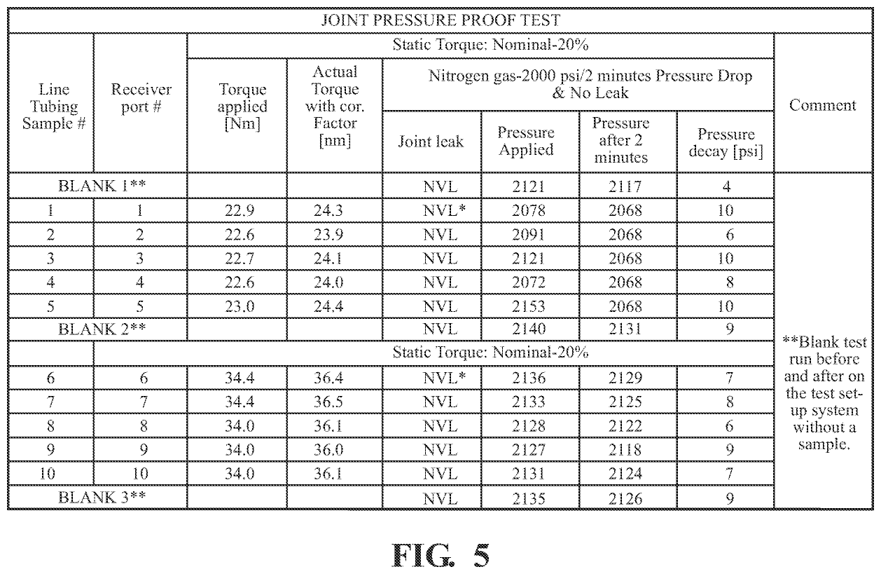

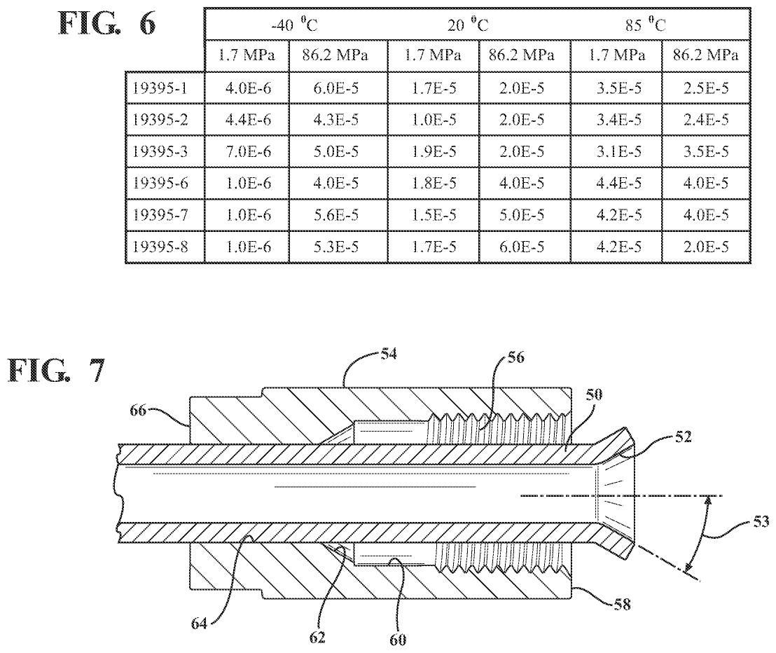

Upon insertion of the male tube end 10 into the female end form 14, the hex or flare nut 12 is displaced forwardly into contact with the male flared end, with the exterior threads, at 30, of the hex nut rotatably interengaging with the interior threads 26 configured upon the female end form in order to establish the sealed connection (further reference to the data surrounding the torque development between the hex nut 12 and the female end form 14 being had with reference to FIGS. 5-6). In this fashion, the mating interface between the male tube 10 and female end form 14 requires a nominal sixty-degree port with the formed tube angle seated to the mating port. The sleeve 18 pressed onto the male tube 10 (see again annular end shoulder abutment location 20) further allows for reduced friction in order to provide the force required to establish the seal.

Without limitation, and beyond that previously described, each of male tube with pressed on sleeve, hex flare nut and female mating port or end-form can all be constructed of a suitable grade steel or other non-corrosive metal. Without limitation, it is also envisioned that the components of the present invention can be constructed of other non-metallic materials including aluminum, as well as durable and rigid polymers and like composites.

With reference now to FIG. 5, a joint pressure proof test chart is presented and which identifies hydrogen joint torque development associated with the connection established with the rotating hex nut in order to establish an optimal sealing force. As explained, the torque specification is based in part on a six sigma analysis of the sealing force required between the threaded nut 12 and the female end form 14, the connection being tested using high pressure nitrogen in a water immersed/submerged environment and by increasing the pressure in each joint to observe the sealing point.

As further described, the torque development steps include each of 1) identifying the six-sigma highest (+3 sigma) torque to seal ratings, 2) multiplying by 1.04 (4%), 3) finding a first torque range for which the lowest variance is higher than the result of (1) and (2), and verifying that the maximum installation torque is less than eight five percent of the six sigma lowest (−3 sigma) torque to failure ratings.

General torque equipment capabilities used to verify the normal torque include each of Standard DC nut runner tongue range nominal+/−15% and Crawford nut (tube nut) runner range nominal+/−20%. The nominal torque is developed using feedback from the design and known torque equipment capabilities. The boundary samples then undergo H2 leak-tightness and high-pressure cycling testing as required for H2 certification.

The table provided in FIG. 5 is an example of the joint verification test utilizing high pressure nitrogen (N2) pressure decay testing over two minutes, and in order to confirm the nominal torque levels.

FIG. 6 presents a further table illustrating torque verification over varying hydrogen test pressures. In this chart, MIN and Max 3 sigma torque samples are subjected to Hydrogen pressure testing with post leak tightness testing. As further shown, this is completed at three different temperatures (−40° C., 20° C. and 85° C.) and two different pressure ratings (1.7 MPa and 86.2 MPa).

Leakage rate (also termed outflow of gas) is measured as M bar L/s which corresponds to a gas pressure drop of 1 mbar within 1 second within a 1 liter volume. As further referenced in FIG. 6, the present design is capable of providing Hydrogen piping performance in order to pass typical H2 certification requirements.

The present invention also discloses a corresponding process for forming a high-pressure leak proof connection assembly between male and female end forms, this including the steps of configuring the female end form to have an interiorly threaded interface and providing the male end form as an elongated tube and flare forming an end of the tube. Other steps include contemporaneously pressing a sleeve onto the tube during flare forming of the male end form, supporting a threaded hex nut over the male tube and, upon insertion of the male tube end into the female end form, displacing the hex nut forwardly into contact with the male flared end. Also included is the step of rotatably interengaging the exterior threads of the hex nut with the interior threads configured upon the female end form in order to establish the sealed connection.

Other steps include the step of rotatably interengaging the exterior threads of the hex nut with the interior threads of the female port or female tube nut further including the step of constructing a joint pressure proof test chart to establish an optimal sealing force between the nut 12 and female end form 14.

The step of testing further including determining a nominal torque utilizing design feedback and known torque equipment capabilities, as well as the step of testing a sealing connection further including conducting a joint verification leak-proof test using high pressure Nitrogen to confirm the nominal torque.

The process further includes the steps of conducting a joint verification leak-proof test of the joint over a two-minute period of time to determine a pressure decay. The step of joint verification testing further including testing at each of three different temperatures and two pressures.

Referring now to FIG. 7, a plan cutaway is shown of a mid-line tube to tube joint connection according to a further embodiment of the present invention. The variant of FIGS. 7-9 provides a tube to tube option for accommodating complex tube routing configurations, and/or which may require a mid-line connection or service access.

A reconfigured female tube is shown at 50 and includes a first flared end profile in the form of an outwardly flared end profile 52 (similar to the first embodiment this can include any suitable angle however is typically in a range of approximately sixty degrees relative to a centerline axis (see at 53). A redesigned female end form is shown at 54 having interior threads 56 extending inwardly from a first open end 58. The interior threads 56 transition to a smooth interior annular surface 60 and, subsequently, to an inward annular flare profile 62 which in turn transitions to a narrowed diameter annular profile 64 extending to a second open end 66 of the female end form 54.

A male tube is shown at 68 in FIG. 9 and is similar to that shown at 10 in FIG. 1. The male tube 68 similarly includes a sleeve 70 (compare to as shown at 18 in FIG. 1) again constructed from such as a 316L stainless steel and which is press fit upon the tube 68 against an outer annular stepped surface 72 which again defines a base of a second flared profile (illustrated as an inwardly flared end profile 74) of the male tube 68.

As shown in the assembled and installed view of FIG. 9, the female tube 50 (via its narrowed diameter 50) and male tube 68 (via its inward flared end 74) are consecutively inserted through the larger diameter first open end 58 of the female end form 54. The female tube 50, upon being fully inserted, seats its outward profile 52 against the mating annular flare profile 62 of the female end form 54, with the forward inward flared end 74 end of the male tube 68 fully inserting into a mating abutment with the outward flare 52 of the female tube 50.

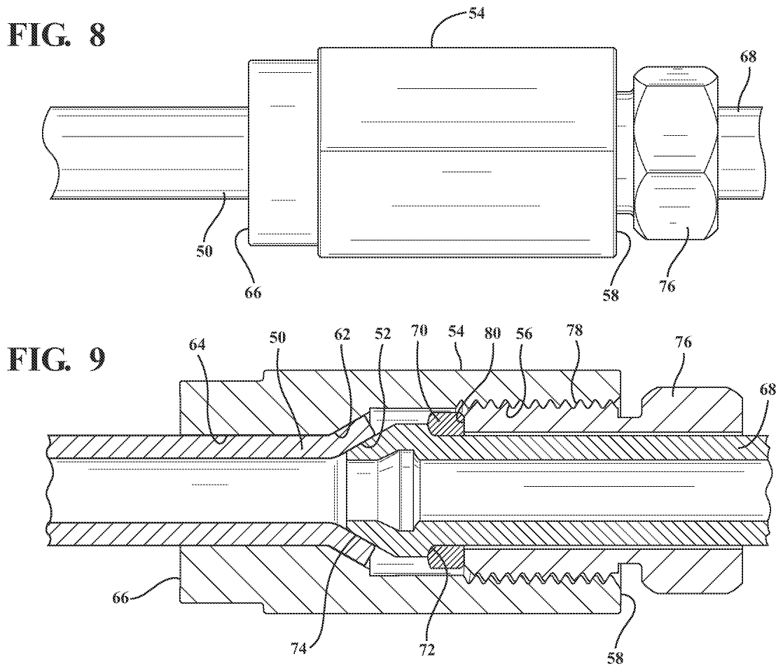

As shown in each of FIGS. 8-9, a threaded hex nut 76 (similar to that depicted at 12 in FIG. 1) is again supported over the male tube 68 and includes a plurality of exterior threads 78 which rotationally inter-engage with the interior annular threads 56 of the female end form 54. Upon being fully installed, a forward end surface 80 of the hex nut 76 biases against the sleeve 70, in turn biasing the opposing mating interface defined between the outward 62 and inward 74 flares of the female 50 and male 68 tubes in order to provide the requisite sealed and leak proof connectivity. Without limitation, the direction of the flared profiles can also be reversed from that shown in which the female tube 50 exhibits an inwardly flared end profile and the male tube 68 an outwardly flared profile.

FIG. 8 presents a succeeding length plan view of an assembled mid-line tube 50 to tube 68 joint end form exhibiting a similar tube flare (again outward end flare 52 of female tube 50 which mates with inwardly end flare 74 of the male tube 68) and nut depicted in the embodiment of FIG. 1 and in which the male nut 76 is threaded into the union. Finally, and a previously noted, FIG. 9 presents a length cutaway of the installed mid-line union joint of FIG. 8 and in which the union is not allowed to rotate while the male nut 76 is torqued per industry operational standards.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A leak proof connection assembly established between a male end form and a female port, comprising:
the female port having an interiorly threaded interface;
the male end form being flare formed upon an elongated tube, a sleeve being pressed on during flare forming;
a threaded hex nut supported over the male tube and, upon insertion of the male end form into the female end form, being displaced forwardly into contact with the male flared end, with the exterior threads of the hex nut rotatably interengaging with the interior threads configured upon the female port in order to establish the sealed connection.

2. The assembly of claim 1, further comprising a mating interface between the male tube and female end forms exhibiting a nominal sixty-degree port with the formed tube angle seated to the mating port.

3. The assembly of claim 1, further comprising a press operation forming the flare end of the male tube.

4. A process for forming a leak proof connection assembly between a male end form and a female port, comprising the steps of:
configuring the female port to have an interiorly threaded interface;
providing the male end form as an elongated tube and flare forming an end of said tube;
contemporaneously pressing a sleeve onto said tube during flare forming of the male end form;
supporting a threaded hex nut over the male tube and, upon insertion of the male tube end into the female port, displacing the hex nut forwardly into contact with the male flared end; and
rotatably interengaging the exterior threads of the hex nut with the interior threads configured upon the female port in order to establish the sealing connection.

5. The process as described in claim 4, said step of rotatably interengaging the exterior threads of the hex nut with the interior threads of the female end form further comprising the step of testing a sealing connection between the nut and female end form.

6. The process as described in claim 5, said step of testing the sealing connection further comprising the step of constructing a joint pressure proof test chart to establish an optimal sealing force between the nut and female end form.

7. The process as described in claim 5, said step of testing further comprising determining a nominal torque utilizing design feedback and known torque development procedures via a six sigma analysis of the sealing force required for establishing the sealing connection.

8. The process as described in claim 7, the step of testing a sealing connection further comprising the step of conducting a joint verification leak-proof test using pressurized Nitrogen to confirm the nominal torque.

9. The process as described in claim 8, the step of conducting a joint verification leak-proof test further comprising the step of testing the joint over a two-minute period of time to determine a pressure decay.

10. The process as described in claim 9, the step of joint verification testing further comprising the step of testing at each of three different temperatures and two pressures, with hydrogen gas used as a test medium to verify torque levels at all conditions.

11. The process as described in claim 10, said different temperatures further comprising −40° C., 20° C. and 85° C.

12. The process as described in claim 10, said pressures further comprising 1.7 MPa and 86.2 MPA at each different temperature.

13. The process as described in claim 9, a leak rate associated with said joint verification testing being rated in M bar L/s.

14. A leak proof connection assembly, comprising:
a male tube having a flared end capturing a sleeve which is supported upon said male tube;
a threaded hex nut supported over said male tube in contact with said sleeve;
a female port including a flare nut having an interiorly threaded interface; and
upon insertion of said male tube into said female flare nut, said hex nut being displaced forwardly into contact with said flared end of said male tube, with exterior threads of said hex nut rotatably interengaging with opposing interior threads configured upon said female flare nut in order to establish the sealed connection.

15. The assembly of claim 14, further comprising a mating interface between said male tube and said female flare nut exhibiting a nominal sixty-degree port with the formed tube angle seated to the mating port.

16. The assembly of claim 14, further comprising a press operation forming the flare end of the male tube.

17. The assembly of claim 14, further comprising a transverse extending pathway within said female end form extending from an internal interface with said flared end of said male tube.

18. A leak proof mid-line connection assembly, comprising:
a female tube having a first flared end profile;
a male tube having a second flared end profile capturing a sleeve which is supported upon said male tube;
a threaded hex nut supported over said male tube in contact with said sleeve;
a female port including a flare nut having an interiorly threaded interface; and
upon successive insertion of said female tube and said male tube into said female port, said hex nut being displaced forwardly into contact with said sleeve, with exterior threads of said hex nut rotatably interengaging with opposing interior threads configured upon said female flare nut in order to establish a sealed connection between a mating interface established between said flared end profiles.

19. The assembly of claim 18, said interior threads of said female port extending inwardly from a first open end, said interior threads transitioning to a smooth interior annular surface and, subsequently, to an inward annular flare profile which in turn transitions to a narrowed diameter annular profile extending to a second open end of said female end form and against which is seated said first flared end profile.

20. The assembly of claim 19, said first flared end profile further comprising an outwardly flared end profile and said second mating profile an inwardly flared end profile.
